(19) United States
(12) Patent Application Publication
(10) Pub. No.: US 2025/0086817 A1
(43) Pub. Date: Mar. 13, 2025

(54) SYSTEMS AND METHODS FOR THREE-DIMENSIONAL SHAPE RECONSTRUCTION

(71) Applicant: George Mason University, Fairfax, VA (US)

(72) Inventors: Jinwei Ye, Fairfax, VA (US); Yuqi Ding, Santee, CA (US)

(21) Appl. No.: 18/882,799

(22) Filed: Sep. 12, 2024

Related U.S. Application Data
(60) Provisional application No. 63/582,178, filed on Sep. 12, 2023.

(51) Int. Cl. G06T 7/586; G06T 17/20

(52) U.S. Cl. CPC G06T 7/586; G06T 17/20

(57) ABSTRACT

A system, such as for three-dimensional (3D) shape reconstruction, includes a polarization camera, a first circularly polarized light source disposed on a first side of the polarization camera, and a second circularly polarized light source disposed on a second side of the polarization camera. The polarization camera is configured to capture first and second images of an object with the respective first and second circularly polarized light sources illuminated. A method and computer readable medium, such as for 3D shape reconstruction, includes obtaining first and second images of an object from a polarization camera corresponding to images of the object captured with respective first and second circularly polarized light sources illuminated, performing polarimetric image decomposition on each of the first and second images, and determining a 3D surface mesh of the object based on the unpolarized and linearly polarized components of the first and second images.

### CROSS-REFERENCE TO RELATED APPLICATIONS

This application claims the benefit of, and priority to, U.S. Provisional Patent Application No. 63/582,178, filed on Sep. 12, 2023, the entire contents of which are hereby incorporated herein by reference.

### BACKGROUND

### Technical Field

The present disclosure relates to systems and methods for three-dimensional (3D) shape reconstruction. More particularly, the present disclosure relates to 3D shape reconstruction systems and methods that leverage both photometric and polarimetric cues to facilitate 3D shape reconstruction in an uncontrolled environment, e.g., under ambient illumination conditions.

### Background of Related Art

Three-dimensional (3D) shape reconstruction is an important, yet challenging, aspect of computer vision that is utilized to digitalize physical objects in the real world into virtual 3D models. Photometric stereo and shape from polarization are two common 3D shape reconstruction methods.

Photometric stereo 3D shape reconstruction involves estimating surface normals from images captured under different lighting conditions. Photometric stereo 3D shape reconstruction is effective when lighting directions are known, such as when performed in a darkroom with calibrated and controlled illumination. To perform photometric stereo 3D shape reconstruction in an uncontrolled environment, the environment light is altered at least three times to provide sufficient photometric constraints, and environment maps of the various lighting conditions are captured for lighting estimation.

Shape from polarization 3D shape reconstruction involves estimating surface normals from shape-dependent polarimetric cues, e.g., the angle or degree of polarization. Shape from polarization 3D shape reconstruction relies on the fundamental assumption that the object is illuminated by completely unpolarized light. However, although direct illumination from many light sources, e.g., the sun, light bulbs, etc., is unpolarized, light becomes partially linearly polarized after scattering, reflection, and refraction and, thus, uncontrolled environment lighting usually has linearly polarized components, for instance, resulting from indirect illumination from a reflector, e.g., a wall, floor, tabletop, etc.

### SUMMARY

Terms including “generally,” “about,” “substantially,” and the like, as utilized herein, are meant to encompass tolerances and variations up to and including plus or minus 10 percent. Further, to the extent consistent, any or all of the aspects detailed herein may be used in conjunction with any or all of the other aspects detailed herein.

In accordance with aspects of the present disclosure, a system, such as for three-dimensional (3D) shape reconstruction, is provided including a polarization camera, a first circularly polarized light source disposed on one side, e.g., a first side, of the polarization camera, and a second circularly polarized light source disposed on another side, e.g., a second side, of the polarization camera. The polarization camera is configured to capture a first image of an object illuminated with the first circularly polarized light source and to capture a second image of the object illuminated with the second circularly polarized light source.

In an aspect of the present disclosure, the polarization camera and the first and second circularly polarized light sources are mounted on or within a housing.

In another aspect of the present disclosure, the 3D shape reconstruction system further includes a controller having a processor and a non-transitory computer readable storage medium storing instructions that, when executed by the processor, cause the processor to determine a 3D surface mesh of the object based on the first and second images.

In another aspect of the present disclosure, determining the 3D surface mesh includes performing polarimetric image decomposition on each of the first and second images to decompose each of the first and second images into an unpolarized component, a linearly polarized component, and a circularly polarized component.

In another aspect of the present disclosure, determining the 3D surface mesh further includes determining a polarimetric constraint based on the linearly polarized components of the first and second images, determining first and second photometrics constraints based on the unpolarized components of the first and second images, determining a surface normal map based on the polarimetric constraint and the first and second photometric constraints, and determining the 3D surface mesh based on the surface normal map.

In still another aspect of the present disclosure, determining the polarimetric constraint includes determining an angle of linear polarization (AoLP) estimation based on the linearly polarized components of the first and second images, respectively. In such aspects, determining the AoLP estimation may include determining a first AoLP estimation based on the linearly polarized component of the first image, determining a second AoLP estimation based on the linearly polarized component of the second image, and fusing the first and second AoLP estimations.

In yet another aspect of the present disclosure, determining the first and second photometric constraints includes determining a lighting proxy map and iteratively refining the first and second photometric constraints using the lighting proxy map.

In still yet another aspect of the present disclosure, determining the surface normal map includes convex optimization of the polarimetric constraint and the first and second photometric constraints. In additional or alternative aspects, determining the 3D surface mesh based on the surface normal map includes integrating surface normals of the surface normal map.

A method, such as for three-dimensional (3D) shape reconstruction, provided in accordance with the present disclosure includes obtaining first and second images of an object from a polarization camera, wherein the first image corresponds to an image of the object illuminated with a first circularly polarized light source and wherein the second image corresponds to an image of the object illuminated with a second circularly polarized light source. The method further includes performing polarimetric image decomposition on each of the first and second images to decompose each of the first and second images into an unpolarized component, a linearly polarized component, and a circularly polarized component. A 3D surface mesh of the object is then determined based on the unpolarized and linearly polarized components of the first and second images.

In an aspect of the present disclosure, determining the 3D surface mesh includes determining a polarimetric constraint based on the linearly polarized components of the first and second images, and determining first and second photometric constraints based on the unpolarized components of the first and second images.

In another aspect of the present disclosure, determining the 3D surface mesh further includes determining a surface normal map based on the polarimetric constraint and the first and second photometric constraints. In such aspects, determining the 3D surface mesh may further include integrating surface normals of the surface normal map.

In still another aspect of the present disclosure, determining the surface normal map includes performing convex optimization on the polarimetric constraint and the first and second photometric constraints.

In yet another aspect of the present disclosure, determining the polarimetric constraint includes determining an angle of linear polarization (AoLP) estimation based on the linearly polarized components of the first and second images, respectively. Determining the AoLP estimation, in such aspects, may include determining a first AoLP estimation based on the linearly polarized component of the first image, determining a second AoLP estimation based on the linearly polarized component of the second image, and fusing the first and second AoLP estimations.

In still yet another aspect of the present disclosure, determining the first and second photometric constraints includes determining a lighting proxy map. In such aspects, determining the first and second photometric constraints may further include iteratively refining the first and second photometric constraints using the lighting proxy map.

Also provided in accordance with the present disclosure is a non-transitory, computer readable storage medium storing instructions that, when executed by a processor, cause the processor to perform a method, such as for three-dimensional (3D) shape reconstruction, including performing polarimetric image decomposition on a first image, captured by a polarization camera, of an object illuminated with a first circularly polarized light source to decompose the first image into an unpolarized component, a linearly polarized component, and a circularly polarized component; performing polarimetric image decomposition on a second image, captured by the polarization camera, of the object illuminated with a second circularly polarized light source to decompose the second image into an unpolarized component, a linearly polarized component, and a circularly polarized component; determining a polarimetric constraint based on the linearly polarized components of the first and second images; determining first and second photometric constraints based on the unpolarized components of the first and second images; and determining a 3D surface mesh of the object based on the polarimetric constraint and the first and second photometric constraints.

### BRIEF DESCRIPTION OF THE DRAWINGS

Various aspects and features of the present disclosure are described hereinbelow with reference to the drawing figures, wherein:

FIG. 1 is a top, perspective view of a three-dimensional (3D) shape reconstruction system provided in accordance with the present disclosure shown performing 3D shape reconstruction of an object;

FIG. 2 is a flow diagram illustrating a method of 3D shape reconstruction provided in accordance with the present disclosure;

FIG. 3A is a polarization image of a spherical object in accordance with the 3D shape reconstruction systems and methods of the present disclosure;

FIGS. 3B-3D are images of the circularly polarized component, the linearly polarized component, and the unpolarized component of the polarization image of FIG. 3A;

FIG. 4A illustrates an image of the spherical object under ambient lighting conditions and the measured angle of linear polarization (AoLP) of the image;

FIG. 4B illustrates the normal-dependent AoLP (ground truth) for the spherical object;

FIG. 4C illustrates first and second AoLPs of respective first and second polarization images in accordance with the present disclosure under ambient lighting conditions with first and second circularly polarized light sources, respectively, illuminating the spherical object, and further illustrating a fused AoLP resulting from fusion of the first and second AoLPs; and

FIG. 5 illustrates the polarization image, the fused AoLP, the recovered normal (surface normal map), and the recovered surface (3D mesh surface) for an example object in each of three different environmental conditions in accordance with the 3D shape reconstruction systems and methods of the present disclosure.

### DETAILED DESCRIPTION

Systems and methods for three-dimensional (3D) shape reconstruction provided in accordance with the present disclosure leverage both photometric and polarimetric cues, e.g., applying both photometric and polarimetric constraints, to facilitate 3D shape reconstruction in an uncontrolled environment, e.g., under ambient illumination conditions, to produce a 3D surface mesh.

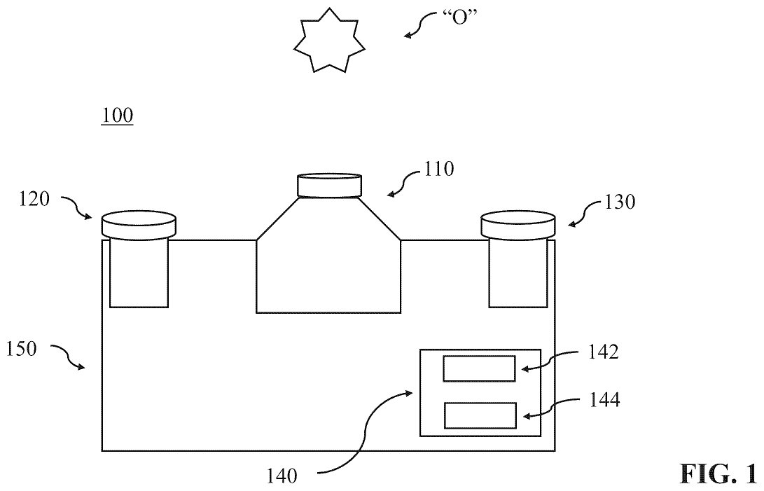

Referring generally to FIG. 1, a 3D shape reconstruction system provided in accordance with the present disclosure is shown generally identified by reference numeral 100. 3D shape reconstruction system 100 includes a polarization camera 110, a first circularly polarized light source 120 disposed on a first side of polarization camera 110, a second circularly polarized light source 130 disposed on a second side of polarization camera 110, and a controller 140 having a processor 142 and memory 144. In aspects, polarization camera 110, first and second circularly polarized light sources 120, 130, respectively, and controller 140 are each disposed on or within a common housing 150, although other configurations are also contemplated such as, for example, wherein controller 140 is part of a remote computer (not shown) connected to polarization camera 110 and first and second circularly polarized light sources 120, 130, respectively, of housing 150 by a wired or wireless connection.

Polarization camera 110 is configured to measure the full Stokes polarization information for each pixel of a captured image, e.g., of an object “O”. In order to enable measurement of the full Stokes polarization information, polarization camera 110 may, for example, be configured as a full-Stokes polarization camera. Alternatively, polarization camera 110 may be configured as a linear polarization camera include a rotating (e.g., motor-driven) retarder (not shown) or other suitable filters to enable measurement of circular polarization. Standard cameras with suitable filters to enable measurement of both linear and circular polarization are also contemplated.

First and second circularly polarized light sources 120, 130 may be configured as spotlights including circular polarization filters in front of the light sources to generate circularly polarized light, although other suitable configurations for generating circular polarized light from circularly polarized light sources 120, 130 are also contemplated. First and second circularly polarized light sources 120, 130 are fixed or fixable relative polarization camera 110. Polarization camera 110 and first and second circularly polarized light sources 120, 130 are geometrically calibrated to determine the relative positions thereof. In fixed configurations, polarization camera 110 and first and second circularly polarized light sources 120, 130 may be pre-calibrated, e.g., during manufacturing, and would not need to be calibrated again. In fixable configurations, polarization camera 110 and first and second circularly polarized light sources 120, 130 are calibrated once the relative positionings of polarization camera 110 and first and second circularly polarized light sources 120, 130 are fixed and are re-calibrated after each repositioning of any of polarization camera 110, first circularly polarized light source 120, or second circularly polarized light source 130.

In aspects, first and second circularly polarized light sources 120, 130 are laterally offset from polarization camera 110, e.g., in a direction substantially perpendicular to the optical axis of polarization camera 110, on opposing sides of polarization camera 110, and are equally spaced from polarization camera 110. However, other positions of first and second circularly polarized light sources 120, 130 relative to polarization camera 110 are also contemplated, e.g., circularly polarized light sources vertically offset from polarization camera 110 in a direction substantially perpendicular to the optical axis of polarization camera 110 on opposing sides and equally spaced from polarization camera 110. Additional circularly polarized light sources are also contemplated, e.g., a plurality of circularly polarized light sources arranged radially about polarization camera 110.

Processor 142 may include one or more digital signal processors (DSPs), general-purpose microprocessors, application-specific integrated circuits (ASICs), field programmable logic arrays (FPGAs), or other equivalent integrated or discrete logic circuitry. Accordingly, the term “processor” as used herein may refer to any of the foregoing structures or any other physical structure suitable for implementation of the techniques described in accordance with this disclosure. These techniques could be fully implemented in one or more circuits or logic elements. In aspects, these techniques may be implemented in hardware, software, firmware, or any combination thereof. If implemented in software, the functions may be stored as one or more instructions or code in memory 144, which may include a non-transitory computer readable medium configured to be executed by a hardware-based processing unit, e.g., processor 142. Memory 144 may include non-transitory computer readable media, which corresponds to a tangible medium such as data storage media (e.g., RAM, ROM, EEPROM, flash memory, or any other medium that can be used to store desired program code in the form of instructions or data structures and that can be accessed by a processor).

Continuing with reference to FIG. 1, shape reconstruction system 100 is configured to capture a first image of the object “O” using polarization camera 110 with first circularly polarized light source 120 illuminating the object “O” and to capture a second image of the object “O” using polarization camera 110 with second circularly polarized light source 130 illuminating the object “O”. Second polarization light source 130 may be turned OFF, e.g., not illuminating the object “O”, during capture of the first image and, likewise, first polarization light source 130 may be turned off, e.g., not illuminating the object “O”, during capture of the second image, although other configurations are also contemplated. The positioning of first and second polarization light sources 120, 130 on respective first and second sides of the polarization camera 110 and the selective illumination of the object “O” with the respective first and second polarization light sources 120, 130 during capture of the first and second images provides different lighting conditions during capture of the first and second images.

Polarization camera 110 and first and second polarization light sources 120, 130, respectively, of 3D shape reconstruction system 100 enable the capture of first and second images each having full Stokes polarization information for each pixel in the image and, thus, each pixel can be represented in the form of the full-Stokes vector S=[S₀, S₁, S₂, S₃] T, wherein S₀ is the total intensity and, assuming the total intensity S₀ is normalized, S₁ is in the range [−1, 1] and represents the state of vertical or horizontal linear polarization, S₂ is in the range [−1, 1] and represents the state of diagonal (45° to −45°) linear polarization, and S₃ is in the range [−1, 1] and represents the state of circular polarization. Thus, for only linearly polarized light, for example, S₃=0. As another example, for only circularly polarized light, S₁=S₂=0. These constraints enable decomposing the images into polarized components, as detailed below.

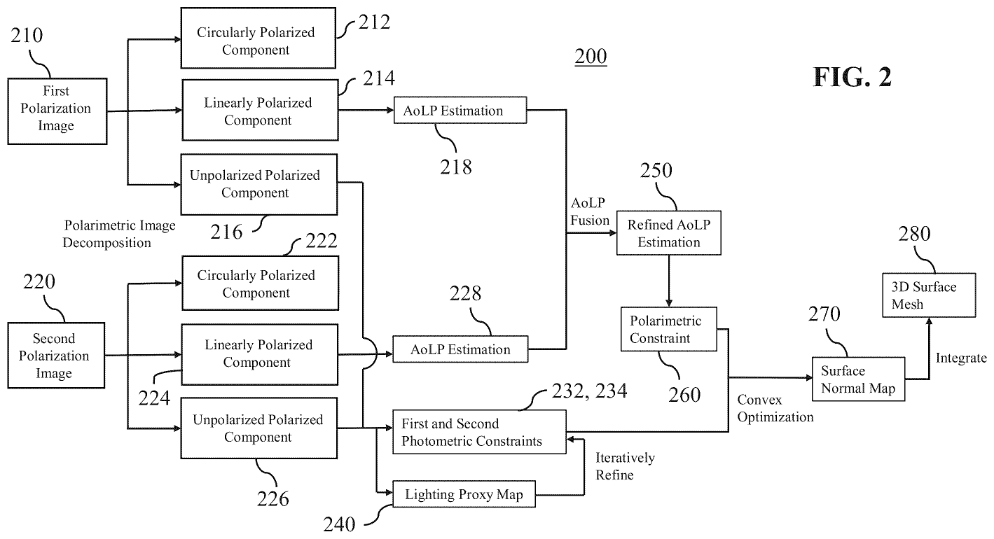

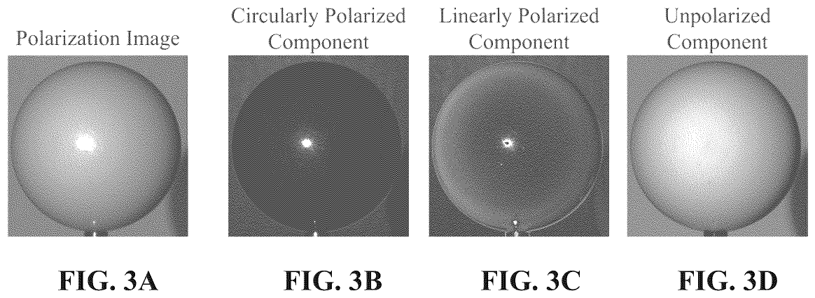

With additional reference to FIG. 2, a method 200 of performing 3D shape reconstruction in accordance with the present disclosure (e.g., using controller 140 of 3D shape reconstruction system 100), is detailed using the first and second images each having full Stokes polarization information for each pixel in the image (e.g., obtained using polarization camera 110 and first and second polarization light sources 120, 130, respectively, of 3D shape reconstruction system 100) as the first input, first polarization image 210, and the second input, second polarization image 220, respectively. Polarimetric image decomposition is performed on each of the inputs, e.g., first and second polarization images 210, 220, to decompose each of the first and second polarization images 210, 220 into a circularly polarized component 212, 222, a linearly polarized component 214, 224, and an unpolarized component 216, 226. The use of first and second polarization light sources 120, 130 in the first and second polarization images 210, 220, respectively, and the subsequent polarimetric image decomposition thereof functions to remove the specular reflection from the unpolarized components 216, 226. See FIGS. 3A-3D.

The use of first and second polarization light sources 120, 130 in the first and second polarization images 210, 220, respectively, also provides photometric parallax such that first and second photometric constraints 232, 234 can be determined from the unpolarized components 216, 226 of the first and second polarization images 210, 220, respectively. The first and second photometric constraints 232, 234 can be determined, in aspects, using the Lambertian reflection model, according to Equation (1):

$$I = pE ( n \cdot L ) ,$$

wherein I is the intensity of reflection, p is the surface albedo, E is the light intensity, n is the surface normal, and L is the lighting direction.

In addition, a lighting proxy map 240 is generated and utilized to iteratively refine the first and second photometric constraints 232, 234. In aspects, lighting proxy map 240 may be determined using only those pixels that have normal estimations with confidence values of 1 as determined using degree of linear polarization (DoLP) as a confidence map. By eliminating inaccurate normals in this manner, a more accurate lighting proxy map 240 is achieved and, thus better refinement of the first and second photometric constraints 232, 234 is achieved.

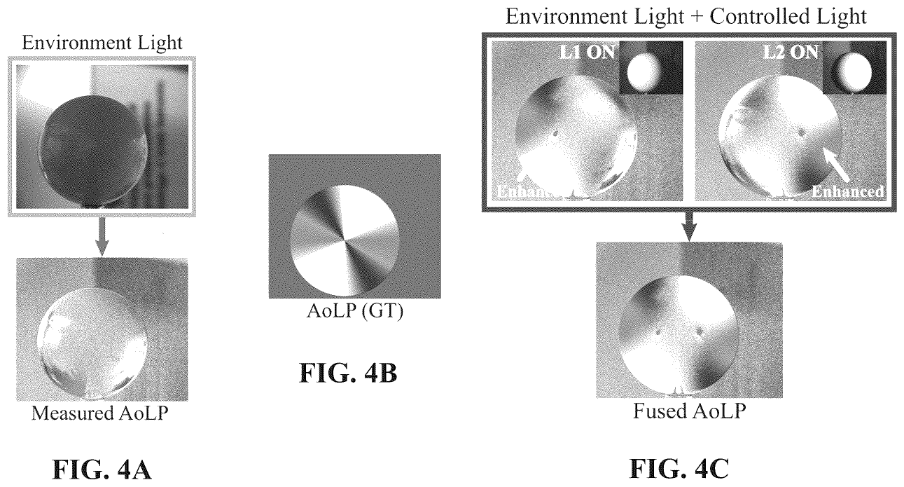

Continuing with reference to FIG. 2, in conjunction with FIG. 1, the linearly polarized components 214, 224 of the first and second polarization images 210, 220, respectively, are utilized to determine a polarimetric constraint 260. More specifically, while ambient light usually has linearly polarized components, for instance, from indirect illumination from surrounding objects (e.g., walls, floors, tabletops, etc.), which can render angle of linear polarization (AoLP) measurements unreliable for normal estimation, the use of first and second polarization light sources 120, 130 close to the object “O” enables the reflections of the circularly polarized light to dominate over the ambient linearly polarized light, thus enabling accurate AoLP estimations 218, 228 from the linearly polarized components 214, 224 of the first and second polarization images 210, 220, respectively. See FIGS. 4A-4C.

The AoLP estimations 218, 228 from the linearly polarized components 214, 224 of the first and second polarization images 210, 220, respectively, are fused to determine a refined AoLP estimation 250 (see FIG. 4C), from which the polarimetric constraint 260 is determined. More specifically, fusion of the AoLP estimations 218, 228 may be performed by comparing the intensities of the linearly polarized components 214, 224 of the first and second polarization images 210, 220, respectively, at each pixel and adopting, for each pixel, the AoLP estimation of with the higher intensity value.

The polarimetric constraint 260 is determined from the refined AoLP estimation 250. The polarimetric constraint 260 may be determined as a linear equation by projecting both the surface normal and AoLP for each pixel onto the image plane. The polarimetric constraint equation, for diffuse reflection pixels, may be represented according to Equation (2):

$$[ sin ( q ) , - cos ( q ) , 0 ] n = 0 ,$$

wherein n=[nₓ, n_{y}, n_{z}]^{T} is surface normal and q is the AoLP.

Regions of the refined AoLP estimation 250 that are inconsistent with the ground truth diffuse AoLP equation map, calculated from the diffuse polarimetric constraint equation provided above (Equation (2)), are considered specular reflections. Thus, a separate polarimetric constraint equation is utilized for specular reflection pixels, according to Equation (3):

$$[ sin ( q + 90 ° ) , cos ( q + 90 ° ) , 0 ] n = 0 .$$

Since specular reflections are usually brighter and have higher degrees of polarization compared to diffuse reflections, thresholding is utilized to separate the diffuse and specular pixels from one another in order to apply the appropriate polarimetric constraint thereto, e.g., Equation (2) and Equation (3), respectively.

With the first and second photometric constraints 232, 234 and the polarimetric constraint 260 determined, optimization may be performed to determine the surface normal map 270. More specifically, the first and second photometric constraints 232, 234, providing the photometric clues, and the polarimetric constraint 260, providing the polarimetric cues, are combined to solve for normal for each pixel and determine a surface normal map. The constraints 232, 234, 260 may be solved using convex optimization, or in any other suitable manner.

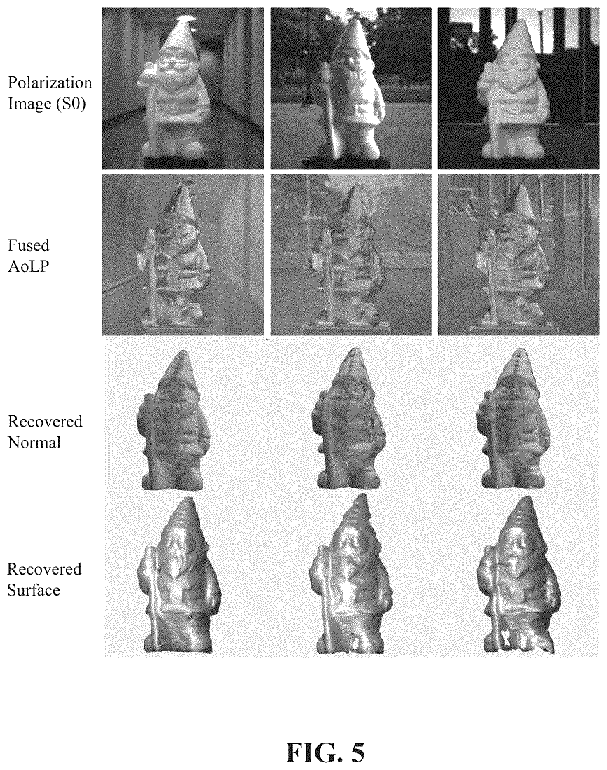

Finally, the surface normals of the surface normal map 270 are integrated to produce a 3D surface mesh 280 of the object “O”. Experimental results in accordance with the present disclosure are shown in FIG. 5. More specifically, FIG. 5 illustrates the polarization image, the fused AoLP, the recovered normal (surface normal map), and the recovered surface (3D mesh surface) for an example object (e.g., a gnome figurine) in each of three different environmental conditions (e.g., indoors, lighter outdoors, and darker outdoors) in accordance with the 3D shape reconstruction systems and methods of the present disclosure.

While several aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed:

1. A system, comprising:
a polarization camera;
a first circularly polarized light source disposed on a first side of the polarization camera; and
a second circularly polarized light source disposed on a second side of the polarization camera,
wherein the polarization camera is configured to capture a first image of an object illuminated with the first circularly polarized light source and to capture a second image of the object illuminated with the second circularly polarized light source.

2. The system according to claim 1, wherein the polarization camera and the first and second circularly polarized light sources are mounted on or within a housing.

3. The system according to claim 1, further comprising a controller having a processor and a non-transitory computer readable storage medium storing instructions that, when executed by the processor, cause the processor to determine a 3D surface mesh of the object based on the first and second images.

4. The system according to claim 3, wherein determining the 3D surface mesh includes performing polarimetric image decomposition on each of the first and second images to decompose each of the first and second images into an unpolarized component, a linearly polarized component, and a circularly polarized component.

5. The system according to claim 4, wherein determining 3D surface mesh further includes:
determining a polarimetric constraint based on the linearly polarized components of the first and second images;
determining first and second photometrics constraints based on the unpolarized components of the first and second images;
determining a surface normal map based on the polarimetric constraint and the first and second photometric constraints; and
determining the 3D surface mesh based on the surface normal map.

6. The system according to claim 5, wherein determining the polarimetric constraint includes determining an angle of linear polarization (AoLP) estimation based on the linearly polarized components of the first and second images, respectively.

7. The system according to claim 6, wherein determining the AoLP estimation includes determining a first AoLP estimation based on the linearly polarized component of the first image, determining a second AoLP estimation based on the linearly polarized component of the second image, and fusing the first and second AoLP estimations.

8. The system according to claim 5, wherein determining the first and second photometric constraints includes determining a lighting proxy map and iteratively refining the first and second photometric constraints using the lighting proxy map.

9. The system according to claim 5, wherein determining the surface normal map includes convex optimization of the polarimetric constraint and the first and second photometric constraints.

10. The system according to claim 9, wherein determining the 3D surface mesh based on the surface normal map includes integrating surface normal of the surface normal map.

11. A method, comprising:
obtaining first and second images of an object from a polarization camera, wherein the first image corresponds to an image of the object illuminated with a first circularly polarized light source and wherein the second image corresponds to an image of the object illuminated with a second circularly polarized light source;
performing polarimetric image decomposition on each of the first and second images to decompose each of the first and second images into an unpolarized component, a linearly polarized component, and a circularly polarized component; and
determining a 3D surface mesh of the object based on the unpolarized and linearly polarized components of the first and second images.

12. The method according to claim 11, wherein determining the 3D surface mesh includes:
determining a polarimetric constraint based on the linearly polarized components of the first and second images; and
determining first and second photometric constraints based on the unpolarized components of the first and second images.

13. The method according to claim 12, wherein determining the 3D surface mesh further includes determining a surface normal map based on the polarimetric constraint and the first and second photometric constraints.

14. The method according to claim 13, wherein determining the 3D surface mesh further includes integrating surface normals of the surface normal map.

15. The method according to claim 13, wherein determining the surface normal map includes performing convex optimization on the polarimetric constraint and the first and second photometric constraints.

16. The method according to claim 12, wherein determining the polarimetric constraint includes determining an angle of linear polarization (AoLP) estimation based on the linearly polarized components of the first and second images, respectively.

17. The method according to claim 16, wherein determining the AoLP estimation includes:
determining a first AoLP estimation based on the linearly polarized component of the first image;
determining a second AoLP estimation based on the linearly polarized component of the second image; and
fusing the first and second AoLP estimations.

18. The method according to claim 12, wherein determining the first and second photometric constraints includes determining a lighting proxy map.

19. The method according to claim 18, wherein determining the first and second photometric constraints further includes iteratively refining the first and second photometric constraints using the lighting proxy map.

20. A non-transitory, computer readable storage medium storing instructions that, when executed by a processor, cause the processor to perform a method comprising:
performing polarimetric image decomposition on a first image, captured by a polarization camera, of an object illuminated by a first circularly polarized light source to decompose the first image into an unpolarized component, a linearly polarized component, and a circularly polarized component;
performing polarimetric image decomposition on a second image, captured by the polarization camera, of the object illuminated by a second circularly polarized light source to decompose the second image into an unpolarized component, a linearly polarized component, and a circularly polarized component;
determining a polarimetric constraint based on the linearly polarized components of the first and second images;
determining first and second photometric constraints based on the unpolarized components of the first and second images; and
determining a 3D surface mesh of the object based on the polarimetric constraint and the first and second photometric constraints.
